(19) United States
(12) Patent Application Publication
(10) Pub. No.: US 2009/0111472 A1
(43) Pub. Date: Apr. 30, 2009

(54) METHOD AND SYSTEM FOR PROVIDING A SEAMLESS HANDOFF BETWEEN COMMUNICATION NETWORKS

(75) Inventors: Edgardo L. Promenzio, Round Lake, IL (US); Ajaykumar R. Idnani, Hoffman Estates, IL (US); Yi-Cheng Liu, Barrington, IL (US); Patrick G. Stephen, South Elgin, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/931,569

(22) Filed: Oct. 31, 2007

(51) Int. Cl. H04Q 7/20

(52) U.S. Cl. 455/439

(57) ABSTRACT

Disclosed is a method that includes initiating a handoff (403) by transmitting a handoff (403) start message to a mobility manager by a first mobile station. The first mobile station is in a call with a second mobile station and moving out from a first communication network to a second communication network. The handoff start message comprises a first call context. The first communication network comprises various network entities such as a SIP server, mobility manager, and the like. The method further includes creating a SIP instance (404) in the mobility manager to hold the first call context. Further, a handoff extension call is placed (405) by the first mobile station to the SIP server via the second communication network and once the handoff extension call is placed, an INVITE message is sent (406) from the SIP server to a preconfigured extension of the mobility manager. The INVITE message comprises a second call context. Thereafter, the handoff extension call is redirected (409) from the second communication network to the first communication network via the mobility manager, in response to the INVITE message received by the preconfigured extension of the mobility manager.

### FIELD OF THE DISCLOSURE

The present disclosure relates generally to a handoff and more particularly to a method and a system for providing a seamless handoff between communication networks.

### BACKGROUND

Mobile stations are known in the art. A mobile station may be a personal device that a user may utilize for various functionalities which are built in the mobile station. Such mobile stations may exhibit mobility before, during, and/or after a call. A call typically comprises the facilitation of communication between two or more mobile stations. In more recent times, increased interest exists with respect to using Session Initiation Protocol (SIP) based platforms to support and facilitate one or more aspects of such calls. Using such an approach, a SIP server can be employed to support various communication activities for the mobile station.

An increasing number of mobile stations utilize multi-network user platforms that are capable of compatible operations in more than one type of communication network. Mobility in this case may lead to a need to handoff the mobile station from one network to another in order to ensure the provision of adequate communication connectivity. At present, when a first communication network, being serviced by a SIP server, hands off a mobile station to a second communication network (for example WLAN to WAN), the SIP server may terminate the call.

Call termination may occur at least in part because all SIP dialogs typically terminate when a corresponding active user leaves a communication network as occurs during such a handoff. In this case, the SIP server may no longer receive status and/or control messages, and/or responses that the SIP server expects to receive from the handed off mobile station. At some point, the SIP server may simply conclude that the corresponding mobile station has been lost and accordingly terminates the call. During such scenarios, end users may object to having their ongoing call abruptly interrupted. In many cases, the user may not receive specific indications that a handoff has occurred. Furthermore, most handoff solutions involve proprietary messaging between a mobility manager and the SIP server and such proprietary messaging that involves the SIP server, prevents the flexible use of a Private branch exchange (PBX) soft switch equipment, thereby restricting the interoperability.

Accordingly, there is a need for an improved method and system to provide a seamless handoff between communication networks.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified and representative system diagram in accordance with some embodiments.

FIG. 2 is a call flow diagram illustrating operation of the system of FIG. 1, in accordance with some embodiments.

FIG. 3 is a call flow diagram illustrating operation of the system of FIG. 1, in accordance with some embodiments.

FIG. 4 is a flowchart illustrating a method of operation of the system of FIG. 1, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before describing in detail embodiments that are in accordance with the invention, it should be observed that the embodiments reside primarily in combinations of method steps and system components for providing a seamless handoff between communication networks. Accordingly, method steps and system components have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. A device or structure that is “configured” in a certain way is configured in at least that way, but may also be configured in ways that are not listed.

Various embodiments of the invention provide a method and system for providing a seamless handoff between communication networks. The method includes initiating a handoff by transmitting a handoff start message to a mobility manager by a first mobile station. The first mobile station is in a call with a second mobile station and moving out from a first communication network to a second communication network. The handoff start message comprises a first call context. The method further includes creating a session initiation protocol (SIP) instance in the mobility manager to hold the first call context. Further, a handoff extension call is placed by the first mobile station to a SIP server via the second communication network and an INVITE message is sent from the SIP server to a preconfigured extension of the mobility manager. The INVITE message comprises a second call context. Thereafter, the handoff extension call is redirected from the second communication network to the first communication network via the mobility manager, in response to the INVITE message received by the preconfigured extension of the mobility manager.

In overview, the present disclosure concerns mobile stations, often referred to as communication units, such as cellular phones, two-way radios, and the like, and communication networks that provide services such as voice and data communication services for such mobile stations. More particularly, various inventive concepts and principles are embodied in systems or constituent elements, mobile stations, and methods therein for providing a seamless handoff of a call between two mobile stations. In communication systems, the call between the two mobile stations may also be known as a communication session, where, in an example the communication session may comprise voice and data exchange between the two mobile stations. It will be apparent to a person with ordinary skill in the art that the communication session may include more than two mobile stations. In one example, a mobile station denotes a device ordinarily associated with a user and typically a wireless mobile station that may be used with a public network in accordance with a service agreement or within a private network. Examples of such mobile stations include but are not limited to personal digital assistants, personal computers equipped for wireless operation, and a cellular handset or device. Such mobile stations may be arranged and constructed for operation in different communication networks.

The mobile stations that are of particular interest to the various embodiments of the present invention are those that may provide or facilitate voice communication services or data or messaging services over wide area networks (WAN), such as conventional two way systems and devices, various cellular phone systems including analog and digital cellular, CDMA (code division multiple access) and variants thereof, GSM, GPRS (General Packet Radio System), 2.5G and 3G systems such as UMTS (Universal Mobile Telecommunication Service) systems, integrated digital enhanced networks and variants or evolutions thereof. Furthermore, the wireless mobile stations or devices of interest have short range wireless communication capability normally referred to as WLAN capabilities, such as IEEE 802.11, Bluetooth, or Hiper-Lan, and the like. These wireless communication capabilities preferably utilize CDMA, frequency hopping, OFDM, or TDMA access technologies and one or more of various networking protocols, such as but not limited to TCP/IP (Transmission Control Protocol/Internet Protocol), UDP/IP (User Datagram Protocol/IP), IPX/SPX (Inter-Packet Exchange/Sequential Packet Exchange), and Net BIOS (Network Basic Input Output System).

The communication networks may utilize some form of protocol for setting up sessions or connections with the mobile stations. Various known protocols may be used, such as H.323 defined and promulgated by the international multimedia telecommunication consortium (IMTC) or SIP as defined by IETF in RFC3261 document. Much of the discussion below, where relevant will assume that SIP and SIP constructs and entities are being utilized in a wireless local area network (WLAN) and that legacy cellular or dispatch protocols are being utilized in the WAN. It will be apparent to a person with ordinary skill in the art that similar functions and methods may be available using other protocols.

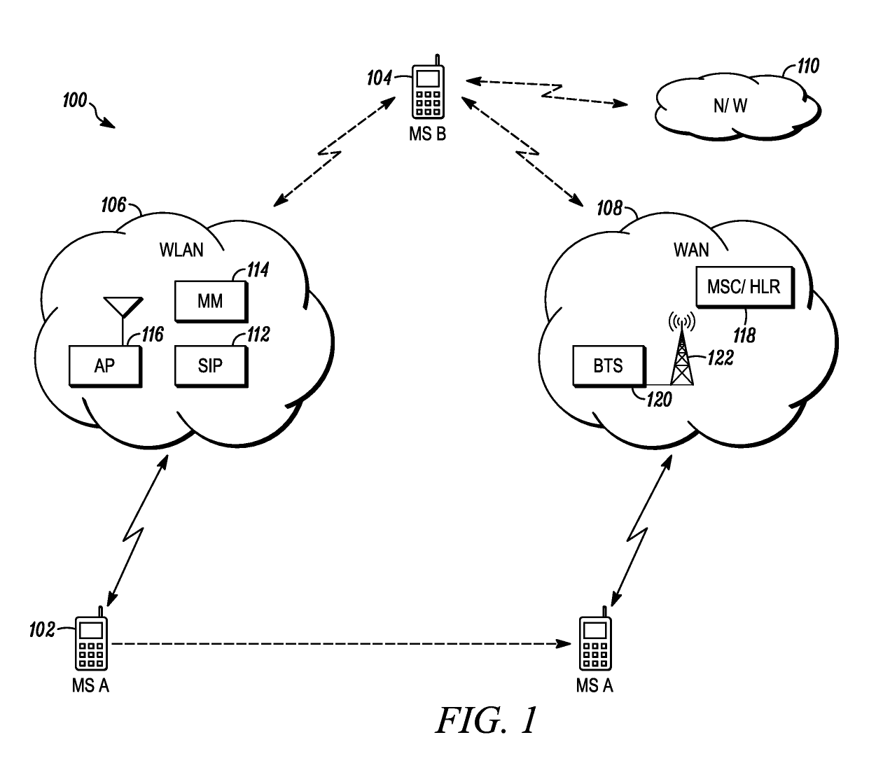

Referring now to the drawings and in particular to FIG. 1, there is shown a simplified and representative system 100 in accordance with some embodiments. The system 100 includes a first mobile station 102, a second mobile station 104, a first communication network 106 comprising a session initiation protocol (SIP) server 112, a mobility manager 114, and an access point 116, a network 110, and a second communication network 108 comprising a mobile switching center/home location register (MSC/HLR) 118, a base transceiver station 120, and a tower 122. It will be apparent to a person with ordinary skill in the art that even though FIG. 1 depicts one SIP server, one access point, one MSC/HLR, one base transceiver station, and one tower, any number of SIP servers, access points, (MSC's/HLR's), base transceiver stations, and towers may be present in the system 100 as represented generally by network 110, and all such embodiments are within the scope of the invention.

In the present embodiment of the invention, the first communication network 106 may be a wireless local area network (WLAN) 106 and the second communication network 108 may be a wireless wide area network (WAN) 108. In one example, the coverage area of the second communication network 108 may be much larger than that of the first communication network 106. The network 110 may be any communication network, for example, a public switched telephone network (PSTN), WLAN, WAN, E1, T1, and the like. Operationally, the first mobile station 102, currently in the first communication network 106, is in a call with a second mobile station 104 and is moving out from the first communication network 106 to the second communication network 108. In one example, the second mobile station 104 may be a stationary mobile station 104 and may be a part of the same network as for the first mobile station 102. Alternatively, the second mobile station 104 may be a part of the network 110.

The SIP server 112 serves as a network switch to facilitate communication between various other network entities of the system 100. The mobility manager 114 may be another network entity which operates to facilitate handoff activities from one network to the other network. A SIP instance (A′) may be created in the mobility manager 114, to hold a call context of the call between the first and the second mobile station 102, 104 that may take many forms but may be sufficient to identify the relevant communication and portions thereof. For example, in a SIP controlled call, the call context may be sufficient to accomplish a call identifier, a source address, a destination address, a sequence identifier, and session description protocol (SDP) information of the call between the first mobile station 102 and the second mobile station 104. In one example, the mobility manager 114 utilizing the SIP instance (A′), exchange messages with the SIP server 112 such that the SIP server 112 does not terminate the call. The access point 116 provides a radio or wireless link to facilitate wireless communication between the first mobile station 102 and the second mobile station 104 or other network entities of the first communication network 106.

The MSC/HLR 118 serves as a network switch to facilitate communication between various other network entities of the system 100. The second communication network 108 typically includes a plurality of base transceivers, antenna towers as well as base site controllers that all serve to provide a radio network access for mobile stations as well as registrars, billing servers, and the like. One such base transceiver station 120 and a corresponding tower 122 is shown in the system 100. It will be apparent to a person with ordinary skill in the art that a large number of network entities that may be a part of typical communication networks are not specifically shown but understood to be present and operational. For example, network routing equipment such as concentrators, routers, etc.

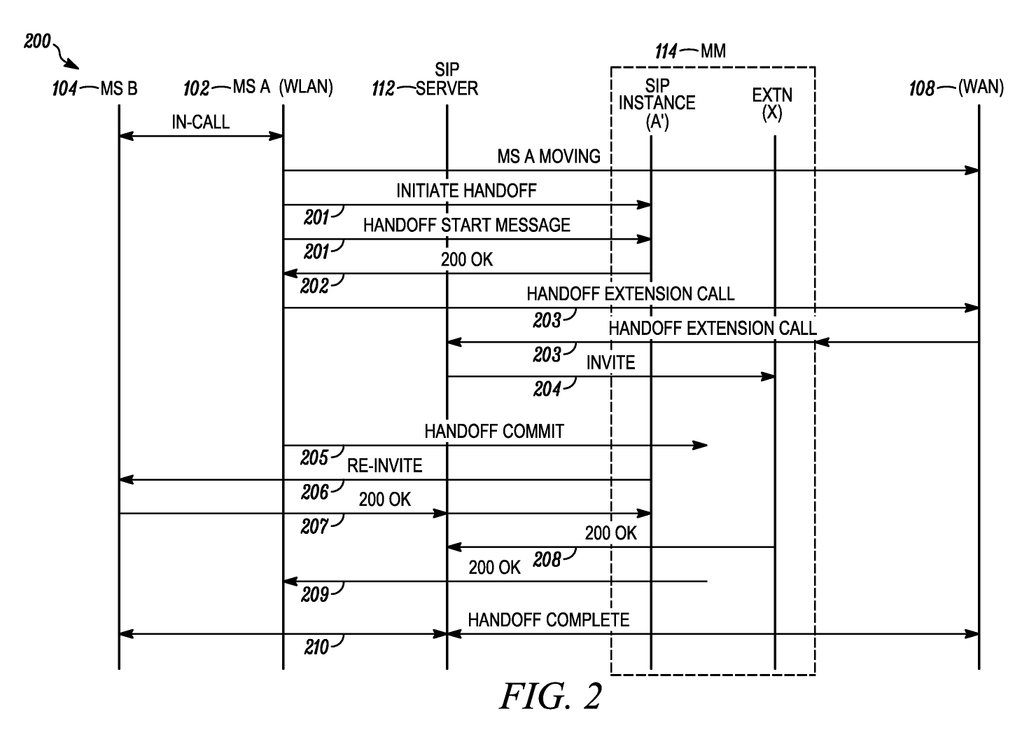

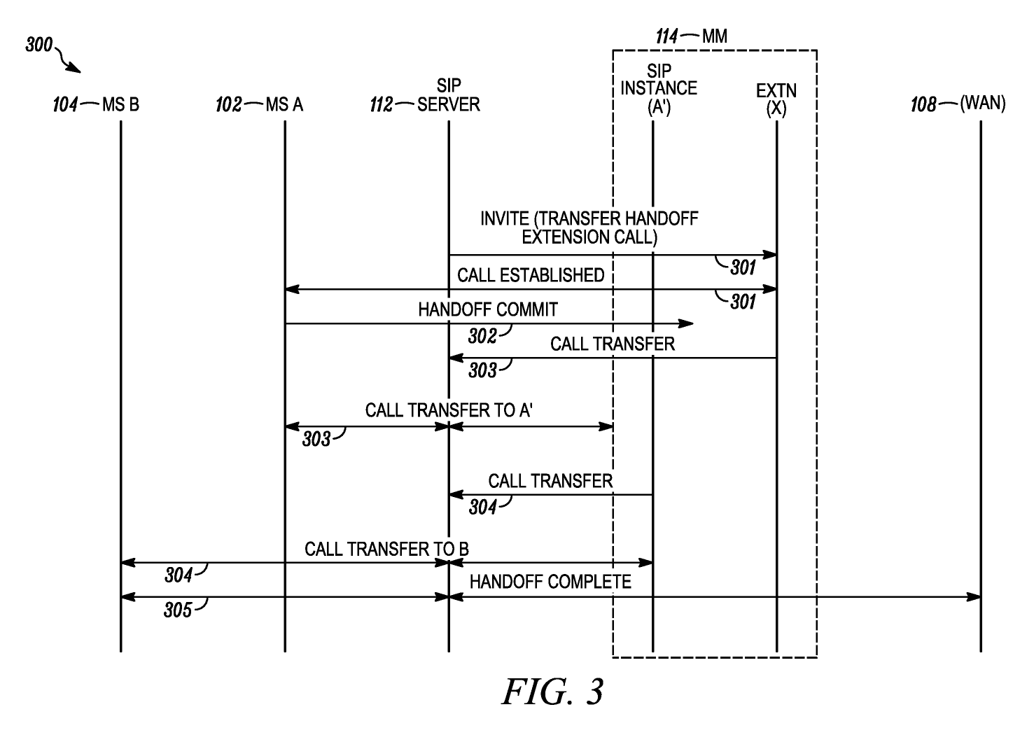

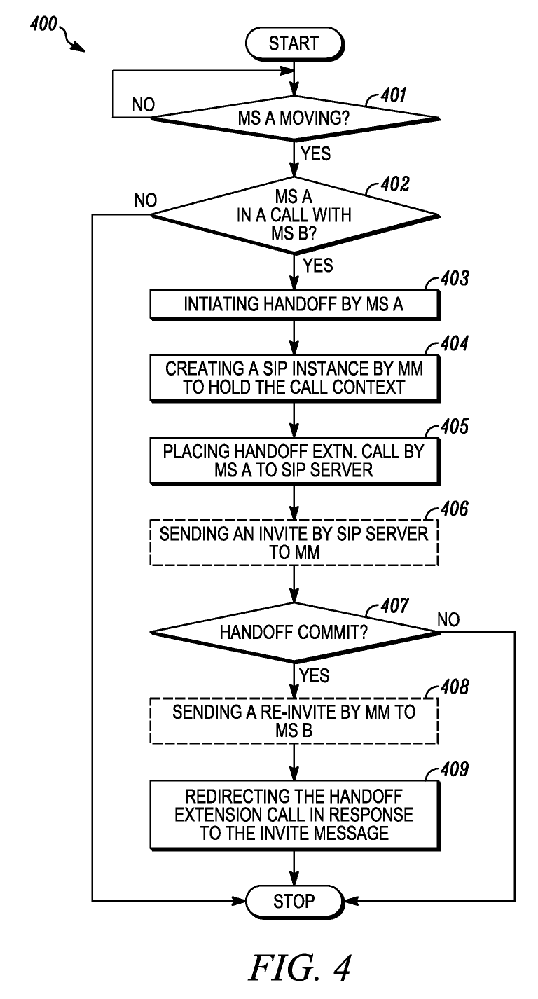

Operationally, in the present embodiment of the invention, the first mobile station 102 is in the call with the second mobile station 104 and moving out from the first communication network 106 to the second communication network 108 creates the SIP instance (A′) in the mobility manager 114 by sending a SIP message, for example, a handoff start message to the mobility manager 114. The SIP instance (A′) created in the mobility manager 114 holds the call context of the call between the first mobile station 102 and the second mobile station 104. The first mobile station 102 places a handoff extension call to the SIP server 112 via the second communication network 108. Further, exchange of SIP messages takes place between the first mobile station 102, the second mobile station 104, the SIP server 112 and the mobility manager 114 until the handoff is complete, which will be described in detail along with the description of FIG. 2, FIG. 3, and FIG. 4. However, it will be apparent to a person with ordinary skill in the art that various other network entities of the first communication network 106 and the second communication network 108 may also be included during and thereby for the completion of the handoff, and will still remain under the scope of the invention.

Referring now to FIG. 2, a call flow diagram 200 illustrating operation of the system 100 in accordance with some embodiments is shown. Generally speaking, the call flow 200 is a specific approach for creating the SIP instance (A′) followed by steps resulting in media stream redirection from the second communication network 108 to the first communication network 106 via the mobility manager 114.

In the present embodiment of the invention, the handoff is initiated when the first mobile station 102 moves out from the first communication network 106 to the second communication network 108. Operationally, a handoff start message 201 may be transmitted by the first mobile station 102 to a SIP instance (A′) created in the mobility manager 114. The handoff start message includes a first call context whereby, the first call context may take many forms but must be sufficient to identify the relevant communication and portions thereof, for example, in a SIP controlled call, the first call context may be sufficient to accomplish a call identifier, a source address, a destination address, a sequence identifier, and session description protocol (SDP) information of the call between the first mobile station 102 and the second mobile station 104. Note that SDP is a protocol for session description, which may be intended for describing multimedia sessions for the purposes of session announcement, session invitation, and other forms of multimedia session initiation. The SIP instance (A′) may be created to hold the first call context. Further the SIP instance (A′) maintains communications with the SIP server 112 (subsequent to the handoff), such that the SIP server 112 does not terminate the call. The specific actions taken will of course vary with the specific requirements of a given application setting. Various SIP instance (A′) configurations are described herein prior to continuing with the description of FIG. 2.

In one example, the mobility manager 114 for the first communication network 106, utilizes a SIP construct, specifically back to back user agents (B2BUA), where each user agent supports communication with one mobile station. The SIP instance (A′) may be created in one such user agent present within the mobility manager 114.

In one embodiment of the invention, the SIP instance (A′) may, for example, automatically respond to at least some messages from the SIP server 112 as are directed to either of the first or the second mobile station 102, 104. Such an automated response may be particularly appropriate for use with respect to SIP server 112 initiated messages that are primarily intended to use in confirming the continued presence and activity of the first mobile station 102 as a part of the SIP server's 112 SIP messaging for the call maintenance.

In another embodiment of the invention, in addition to that presented above or in lieu thereof, the SIP instance (A′) can be configured and arranged to automatically forward at least some messages from the SIP server 112 as are directed to either of the first or the second mobile station 102, 104. The present embodiment may be particularly useful, for example, with respect to handling specific messages that may better be handled other than by an automated response. Messages, such as final response message, for example, an acknowledgement message or a 200 OK message, may be forwarded from the SIP instance (A′) to either of the first or the second mobile station 102, 104 using a bearer channel of choice and/or opportunity.

In another embodiment of the invention, and again in combination with either of the above suggested embodiments or in lieu thereof, the SIP instance (A′) may be configured and arranged to send at least one command message from or to the SIP server 112. Such a command message may comprise, for example, a response to a forwarded message as has been forwarded by the SIP instance (A′) or may comprise a command message such as an instruction to place, for example, a RE-INVITE message to the second mobile station 104.

If desired, the SIP instance (A′) can be programmed and configured to automatically forward only some, and not necessarily all, messages as are received from the SIP server 112 and/or either of the first or the second mobile station 102, 104. Such discretion and/or selectivity can be particularly useful when deployed in conjunction with the described ability to source an automated response to the originating element.

It will be apparent to a person with ordinary skill in the art that the SIP instance (A′) may be provided with a corresponding capability to (itself or via a remote agent) translate messages to be forwarded into an appropriate compatible protocol to ensure compatible reception by the intended forwarding recipient. Protocol-to-protocol translation comprises a well-understood area of endeavor and requires no further elaboration here.

Configuring and programming the SIP instance (A′) to automatically respond to and/or otherwise forward messages to and from the first mobile station 102, as described above may serve a variety of purposes. At a minimum, such activity may serve, wholly or partially, to convince the SIP server 112 of the first mobile station's 102 effective presence such that the SIP server 112 does not terminate the call. Beyond this, such actions may further serve to provide the end user with a relatively transparent, seamless service experience. Such capability will also be understood as facilitating improved or even optimized signaling activity with respect to the system(s) itself.

Returning back to the operation of the call flow 200, the SIP instance (A′), upon receiving the handoff start message 201 responds with an acknowledgement message 202, to acknowledge the receipt of the handoff start message 201. The acknowledgment message 202 may also be known as a 200 OK message 202. Further, the first mobile station 102 after a successful registration with the second communication network 108, places a handoff extension call 203 to the SIP server 112 via the second communication network 108. The handoff extension call 203 is placed using a handoff number that may be a predetermined number that is programmed into one of or both of the mobile stations 102, 104 and various other network entities of the system 100, for example, mobility manager 114. In one example, if the handoff number is programmed into only one of the various other network entities or either of the mobile stations 102, 104, the one with the number can provide the handoff number to the other.

In the present embodiment of the invention, the mobile station 102 may comprise a transceiver that may be suitable to support an air interface with the first communication network 106 and the second communication network 108. The mobile station 102 may also comprise a controller that may be coupled to the transceiver and configured to obtain the handoff number that terminates at any network entity present in the first communication network 106, for example, the mobility manager 114. In one example, the handoff number may be useable to facilitate the handoff of the call between the first mobile station 102 and the second mobile station 104 from the first communication network 106 to the second communication network 108. The first mobile station 102, specifically the controller operating with the transceiver may obtain the handoff number during the setup of the call. In one example, for the first communication network 106 using SIP messaging or call setup processes, the handoff number may be obtained, depending on which mobile station 102, 104 initiates setting up the call.

According to one embodiment of the invention, the SIP server 112 sends a SIP INVITE message 204 to a preconfigured extension (X) of the mobility manager 114. In one example, the preconfigured extension (X) may be configured to receive and respond to SIP messages in order to maintain the call between the first mobile station 102 and the second mobile station 104. The SIP INVITE message 204 includes a second call context that may take many forms but must be sufficient to identify the relevant communication and portions thereof. For example, in the SIP controlled call, the second call context may be sufficient to accomplish a call identifier, a source address, a destination address, a sequence identifier, and session description protocol (SDP) information of the handoff extension call between the first mobile station 102 and the second mobile station 104 via the second communication network 108.

In one embodiment of the present invention, the first mobile station 102 sends a SIP handoff commit message 205 to the mobility manager 114. On receipt of the handoff commit message 205, the mobility manager 114, sends a SIP RE-INVITE message 206 to the second mobile station 104. In one example, the SIP instance (A′) may send the SIP RE-INVITE message 206 to the second mobile station 104. The SIP RE-INVITE message 206 may include the second call context. Note that, in a SIP based system sending the SIP RE-INVITE message 206 or the INVITE message 204 is a good way to change an IP address and port to those that are to be used by the second mobile station 104 for a real time transport protocol (RTP) bearer for the call. These messages request that the second mobile station 104 route its voice bearer RTP to the RTP port, for example, RTP port P, associated with the SIP RE-INVITE message 206 or the INVITE message 204, rather than the first mobile station 102.

Further, the second mobile station 104 replies to the SIP RE-INVITE message 206 with an acknowledgement message 207. For example, the acknowledgment message 207 may be known as a 200 OK message 207. The acknowledgement message 207 may comprise session description protocol (SDP) information of the second mobile station 104.

The mobility manager 114 further sends an acknowledgement message 208 to the SIP server 112, in response to receiving the acknowledgment message 207 from the second mobile station 104. The acknowledgement message 208 may be a 200 OK message 208 comprises SDP information of the second mobile station 104. Further, the mobility manager 114 acknowledges the first mobile station 102 in response to the handoff commit message 205 by sending an acknowledgement message 209. The acknowledgement message 209 may be a 200 OK message 209.

Finally, the handoff is complete 210 and the handoff extension call 203 is redirected from the second communication network 108 to the first communication network 106 via the mobility manager 114. In one example, the handoff extension call 203 is redirected in response to the SIP INVITE message 204 received by the preconfigured extension (X) of the mobility manager 114. In this case, an audio bearer may be established between the first mobile station 102, presently in the second communication network 108, and the second mobile station 104 through a pulse code modulation (PCM) codec from the second communication network 108 and an RTP codec from the first communication network 106. The transcoding for both the codecs may be done by the SIP server 112. In one example, on completion of the handoff 210, no SIP BYE message may be transmitted as the second mobile station 104 may still be in a call with the first mobile station 102. The first mobile station 102 may terminate the call by releasing the resources of the first communication network 106 devoted to the call.

Referring now to FIG. 3, as an alternate embodiment of the invention, if desired or in lieu of steps 204 to 209, an INVITE message 301 may transfer the handoff extension call 203 from the SIP server 112 to the preconfigured extension (X) of the mobility manager 114. Further, the handoff extension call 203 may be established between the first mobile station 102 and preconfigured extension (X) of the mobility manager 114, using the handoff number from the second communication network 108. In one embodiment of the invention, the controller in the first mobile station 102 may be coupled to the transceiver and configured to obtain the handoff number that terminates at any network entity present in the first communication network 106, for example, the mobility manager 114 as mentioned in FIG. 2. In one example, the controller controls the transceiver to place the handoff extension call 203, using the SIP messaging, for example, SIP INVITE message, via the second communication network 108.

In the present embodiment of the invention, on receipt of a SIP handoff commit message 302 by the mobility manager 114 from the first mobile station 102, the preconfigured extension (X) may be utilized, to initiate a first call transfer process 303. The first call transfer 303 may transfer the handoff extension call 203 from the second communication network 108 to the SIP instance (A′) created in the mobility manager 114. In one example, during the first call transfer process 303 the handoff extension call 203 from the second communication network 108 may be first transferred to the SIP server 112 and then via the SIP server 112 the handoff extension call 203 may be transferred to the SIP instance (A′).

Furthermore, the SIP instance (A′) may be utilized, to initiate a second call transfer process 304, that may transfer the handoff extension call 203 from the SIP instance (A′) to the second mobile station 104. In one example, during the second call transfer process the handoff extension call 203 may be first transferred to the SIP server 112 and then via the SIP server 112 the handoff extension call 203 may be transferred to the second mobile station 104.

Finally, the handoff is complete 305 and the handoff extension call 203 is redirected from the second communication network 108 to the first communication network 106 via the mobility manager 114. In one example, once, the handoff extension call 203 has been redirected, the controller controls and operates with the transceiver to switch the call to the second communication network 108 and to discontinue the call with the first communication network 106. In one example, at the end of the second call transfer process 304, an audio bearer may be established between the first mobile station 102, presently in the second communication network 108, and the second mobile station 104, for example, through a pulse code modulation (PCM) codec from the second communication network 108 and an RTP codec from the first communication network 106. The transcoding for both the codecs may be done by the SIP server 112. In one example, on completion of the handoff 305 no SIP BYE message may be transmitted as the second mobile station 104 may still be in a call with the first mobile station 102. The first mobile station 102 may terminate the call by releasing the resources of the first communication network 106 devoted to the call. Note that the SIP BYE messages are a part of the SIP messaging that may be used to end the call between the first mobile station 102 and the second mobile station 104.

Referring now to FIG. 4, a flowchart illustrating a method 400 of operation on the system 100, in accordance with some embodiments. The method 400 is described with reference to FIG. 2 and FIG. 3. In the present embodiment of the invention, at step 401, any network entity of the first communication network 106, for example, access point 116, determines whether the first mobile station 102 is moving out from the first communication network 106 to the second communication network 108. If so, at step 402, any network entity of the first communication network 106, for example, access point 116, determines whether the first mobile station 102 is in a call with the second mobile station 104.

At step 403, handoff is initiated by the first mobile station 102 after it is determined that the first mobile station 102 is moving out from the first communication network 106 and is in a call with the second mobile station 104. In one example, as mentioned above, the handoff start message 201 may be transmitted by the first mobile station 102 to the SIP instance (A′) created in the mobility manager 114. The SIP instance (A′) upon receiving the handoff start message 201 may respond with the acknowledgement message 202 to acknowledge the receipt of the handoff start message 201. The acknowledgment message 202 may also be known as a 200 OK message 202.

Further at step 404, the SIP instance (A′) is created in the mobility manager 114 to hold the first call context. As explained in FIG. 2, the first call context may take many forms but must be sufficient to identify the relevant communication and portions thereof. At step 405, the handoff extension call 203 is placed to the SIP server 112 by the first mobile station 102 via the second communication network 108. In one example, as mentioned above, the handoff extension call 203 is placed using the handoff number that may be a predetermined number which is programmed into one of or both of the mobile stations 102, 104, and the various network entities of the system 100, for example, mobility manager 114.

In one embodiment of the invention, at step 406, the SIP INVITE message 204 is sent to the mobility manager 114 by the SIP server 112. In one example, the SIP INVITE message 204 is sent to the preconfigured extension (X) of the mobility manager 114. At step 407, once the SIP handoff commit message 205 is received by the mobility manager 114, the SIP RE-INVITE message 206 is sent to the second mobile station 104 by the mobility manager 114 in response to the SIP handoff commit message 205, at step 408. In one example, the SIP RE-INVITE message 206 is sent by the SIP instance (A′) created in the mobility manager 114. As explained in FIG. 2, the second mobile station 104 responds to the SIP RE-INVITE message 206 with the acknowledgement message 207. The acknowledgement message 207 may comprise session description protocol (SDP) information of the second mobile station 104. The mobility manager 114 further sends an acknowledgement message 208 to the SIP server 112 in response to the acknowledgment message 207 received from the second mobile station 104.

Finally, at step 409, the handoff extension call 203 is redirected from the second communication network 108 to the first communication device 106 via the mobility manager 114. In one example, the handoff extension call 203 is redirected in response to the SIP INVITE message 204, received by the preconfigured extension (X) of the mobility manager 114. In this case, an audio bearer may be established between the first mobile station 102, presently in the second communication network 108, and the second mobile station 104 through a pulse code modulation (PCM) codec from the second communication network 108 and an RTP codec from the first communication network 106. The transcoding for both the codecs may be done by the SIP server 112.

It will be apparent to a person with ordinary skill in the art that the above described steps comprise but one illustrative technique that may be employed for there purposes. As another illustrative example, if desired and in lieu of steps 406 and 408. At step 406, the handoff extension call 203 may be transferred through the SIP INVITE message 301 to the preconfigured extension (X) of the mobility manager 114 by the SIP server 112. Further, on receipt of the handoff commit message 302, the preconfigured extension (X) may be utilized, to initiate the first call transfer process 303, that may transfer the handoff extension call 203 from the second communication network 108 to the SIP instance (A′) created in the mobility manager 114. At step 407, once the SIP handoff commit message 302 is received by the mobility manager 114, at step 408 the SIP instance (A′) may be utilized, to initiate a second call transfer process 304, that may transfer the handoff extension call 203 from the SIP instance (A′) to the second mobile station 108.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for providing a seamless handoff between communication networks, comprising:
initiating a handoff by a first mobile station by transmitting a handoff start message (201) comprising a first call context to a mobility manager, the first mobile station in a call with a second mobile station and moving out from a first communication network to a second communication network;
creating a session initiation protocol (SIP) instance in the mobility manager to hold the first call context;
placing a handoff extension call by the first mobile station to a SIP server via the second communication network;
sending an invite message comprising a second call context from the SIP server to a preconfigured extension of the mobility manager; and
redirecting the handoff extension call from the second communication network to the first communication network via the mobility manager, in response to the invite message received by the preconfigured extension of the mobility manager.

2. The method of claim 1, further comprising, sending a re-invite message by the mobility manager to the second mobile station in response to receiving a handoff commit message from the first mobile station, wherein the re-invite message comprises the second call context.

3. The method of claim 2 further comprising, receiving an acknowledgement message by the mobility manager from the second mobile station in response to the re-invite message, wherein the acknowledgement message comprises session description protocol (SDP) information of the second mobile station

4. The method of claim 3 further comprising, sending the acknowledgement message to the SIP server from the mobility manager, wherein the acknowledgement message comprises session description protocol (SDP) information of the second mobile station.

5. The method of claim 1, wherein the invite message further transfers the handoff extension call from the SIP server to the preconfigured extension of the mobility manager.

6. The method of claim 5, further comprising, utilizing the preconfigured extension to initiate a first call transfer process for transferring the handoff extension call from the second communication network to the SIP instance created in the mobility manager, in response to a handoff commit message received by the mobility manager from the first mobile station.

7. The method of claim 6 further comprising, utilizing the SIP instance to initiate a second call transfer process for transferring the handoff extension call from the SIP instance to the second mobile station.

8. The method of claim 1, wherein the first communication network is a wireless local area network (WLAN) and the second communication network is a wireless wide area network (WAN).

9. The method of claim 1, wherein the second mobile station is a stationary mobile station.

10. The method of claim 1, wherein the first call context comprises at least one of a call identifier, a source address, a destination address, a sequence identifier, and session description protocol (SDP) information of the call between the first mobile station and the second mobile station.

11. The method of claim 1, wherein the second call context comprises at least one of a call identifier, a source address, a destination address, a sequence identifier, and session description protocol (SDP) information of the handoff extension call between the first mobile station and the second mobile station via the second communication network.

12. A system for providing a seamless handoff between communication networks, the system comprising:
a first mobile station, in a call with a second mobile station and moving out from a first communication network to a second communication network, the first mobile station:
for initiating a handoff by transmitting a handoff start message comprising a first call context, and
for placing a handoff extension call via the second communication network;
a SIP server:
for receiving the handoff extension call from the first mobile station,
for sending an invite message comprising a second call context to a preconfigured extension of the mobility manager in response to the handoff extension call; and
a mobility manager:
for receiving the handoff start message,
for creating a session initiation protocol (SIP) instance to hold the first call context received with the handoff start message, and
for redirecting the handoff extension call from the second communication network to the first communication network in response to the invite message received by the preconfigured extension of the mobility manager.

13. The system of claim 12, wherein the mobility manager and the SIP server are part of the first communication network.

14. The system of claim 12, wherein the mobility manager sends a re-invite message to the second mobile station in response to receiving a handoff commit message, wherein the re-invite message comprises the second call context.

15. The system of claim 14, wherein the mobility manager receives an acknowledgement message from the second mobile station in response to the re-invite message, wherein the acknowledgement message comprises session description protocol (SDP) information of the second mobile station.

16. The system of claim 15, wherein the mobility manager sends an acknowledgement message to the SIP server, wherein the acknowledgement message comprises session description protocol (SDP) information of the second mobile station.

17. The system of claim 12, wherein the invite message further transfers the handoff extension call from the SIP server to the preconfigured extension of the mobility manager.

18. The system of claim 17, wherein the mobility manager utilizes the preconfigured extension to initiate a first call transfer process for transferring the handoff extension call from the second communication network to the SIP instance created in the mobility manager.

19. The system of claim 18, wherein the mobility manager utilizes the SIP instance to initiate a second call transfer process for transferring the handoff extension call from the SIP instance to the second mobile station.

20. The system of claim 12, wherein the first call context comprises at least one of a call identifier, a source address, a destination address, a sequence identifier, and session description protocol (SDP) information of the call between the first mobile station and the second mobile station.

21. The system of claim 12, wherein the second call context comprises at least one of a call identifier, a source address, a destination address, a sequence identifier, and session description protocol (SDP) information of the handoff extension call between the first mobile station and the second mobile station via the second communication network.
